(19) United States
(12) Patent Application Publication
(10) Pub. No.: US 2017/0299432 A1
(43) Pub. Date: Oct. 19, 2017

(54) SPECTROSCOPIC DATA PROCESSING APPARATUS, IMAGE CAPTURING APPARATUS, SPECTROSCOPIC DATA PROCESSING METHOD, AND STORAGE MEDIUM FOR STORING SPECTROSCOPIC DATA PROCESSING PROGRAM

(71) Applicant: CANON KABUSHIKI KAISHA, Tokyo (JP)

(72) Inventor: Takeshi Watanabe, Saitama-shi (JP)

(21) Appl. No.: 15/473,772

(22) Filed: Mar. 30, 2017

(30) Foreign Application Priority Data
Apr. 15, 2016 (JP) 2016-081970

(51) Int. Cl. G01J 3/02; G01J 3/45; G01J 3/28

(52) U.S. Cl. CPC G01J 3/0297; G01J 3/2823; G01J 3/45

(57) ABSTRACT

A spectroscopic data processing apparatus configured to process first interferogram data obtained by separating through a spectroscopic optical system light on a slit imaged by an image capturing optical system and by capturing an image through an image sensor includes a first processor configured to deconvolute the first interferogram data using first information relating to the slit and the image sensor when the first interferogram data is obtained and to generate second interferogram data, a second processor configured to generate multi-spectral data by Fourier-transforming the second interferogram data, and a third processor configured to generate corrected multi-spectral data by performing a correction process for the multi-spectral data using second information relating to an optical transfer function or a point spread function of the image capturing optical system.

### BACKGROUND OF THE INVENTION

### Field of the Invention

The present invention relates to the hyperspectral imaging technology.

### Description of the Related Art

The conventional hyperspectral imaging obtains spectral information that is split into many wavelengths, as information on a space in which there are a variety of objects. One hyperspectral imaging method is a so-called Fourier spectroscopy type method that obtains an interference fringe of light and restores spectral data on a computer. The spectral information of a wider object space can be obtained by using an image capturing system that splits, through a spectroscopic optical system, light on a slit imaged by an image capturing optical system and photoelectrically converts light through an image sensor.

Japanese Patent Laid-Open No. (“JP”) 2015-111169 discloses multi-channel Fourier spectroscopic imaging that includes a multi-channel Fourier spectrometer as a simple optical system and performs a spectroscopic measurement. JP 06-331440 discloses a method of obtaining precise spectral information by deconvoluting a spectral area in a Fourier spectroscopic type method.

However, the multi-channel Fourier spectroscopic imaging using the image capturing optical system and the slit has a problem in obtaining the hyperspectral data: The wavelength resolution of the hyperspectral data or the data precision degrades due to an image degradation caused by the aberration and diffraction in the image capturing optical system and a spectrum degradation caused by the spectral averaging and response characteristic in the slit. Moreover, the data precision changes according to the optical parameter in the spectroscopic optical system and the pixel parameter in the image sensor. JPs 2015-111169 and 06-331440 are silent about a method for effectively preventing a degradation of the data precision in the hyperspectral imaging.

### SUMMARY OF THE INVENTION

The present invention provides a spectroscopic data processing apparatus that can restrain a degradation of data precision caused by an image degradation in an image capturing optical system and a spectrum deterioration in a slit in the hyperspectral imaging.

A spectroscopic data processing apparatus is configured to process first interferogram data obtained by separating through a spectroscopic optical system light on a slit imaged by an image capturing optical system and by capturing an image through an image sensor. The spectroscopic data processing apparatus includes a first processor configured to deconvolute the first interferogram data using first information relating to the slit and the image sensor when the first interferogram data is obtained and to generate second interferogram data, a second processor configured to generate multi-spectral data by Fourier-transforming the second interferogram data, and a third processor configured to generate corrected multi-spectral data by performing a correction process for the multi-spectral data using second information relating to an optical transfer function or a point spread function of the image capturing optical system.

Further features of the present invention will become apparent from the following description of exemplary embodiments with reference to the attached drawings.

### BRIEF DESCRIPTION OF THE DRAWINGS

FIG. 1 is a flowchart of spectroscopic data processing according to a first embodiment of the present invention.

FIG. 2 is a conceptual view of the spectroscopic data processing according to the first embodiment.

FIGS. 3A to 3D are conceptual views of an interferogram according to the first embodiment.

FIGS. 4A and 4B are illustrative views of multi-spectral data and SPF of the image capturing optical system according to the first embodiment.

FIG. 5 is a flowchart of spectroscopic data processing according to a second embodiment of the present invention.

FIG. 6 is a structural view of an image capturing apparatus configured to obtain first interferogram data for which the spectroscopic data processing is performed according to the first embodiment.

### DESCRIPTION OF THE EMBODIMENTS

Referring now to the accompanying drawings, a description will be given of embodiments of the present invention.

### First Embodiment

FIG. 6 illustrates a configuration of an image capturing apparatus 100 that includes a data processor 106 as a spectroscopic data processing apparatus according to a first embodiment of the present invention configured to perform spectroscopic data processing in multi-channel Fourier spectroscopic imaging as hyperspectral imaging. The image capturing apparatus 100 includes an image capturing optical system 101, a slit 102, a spectroscopic optical system 103, and an image sensor 104. An image capturing system includes the image capturing optical system 101, the slit 102, the spectroscopic optical system 103, and the image sensor 104. The image capturing system images light from an object 105 to be captured or measured, onto the slit 102 having a predetermined width through the image capturing optical system 101. The spectroscopic optical system 103 separates line-shaped light that has passed the slit 102, and the image sensor 104 captures an image or photoelectrically converts the separated light as a whole, generating spectroscopic data referred to as interferogram (interference fringe or interference image) data.

The interferogram is a superimposition of interference patterns with a variety of wavelength components that continuously distribute in a specific wavelength range or wave number range. This embodiment refers to interferogram data obtained by the image sensor 104, as first interferogram data. The first interferogram data, as used herein, is row data obtained by simultaneously capturing light that has passed a plurality of areas (referred to as “inter-slit areas”) in the slit 102 from a multiplicity of object points on the object 105 and been separated by the spectroscopic optical system 103.

When the object 105 and the slit 102 relatively are moved in the width direction of the slit 102, the first interferogram data for the object 105 is time-divisionally acquired for each slit-shaped image capturing area captured by the image sensor 104.

The spectroscopic optical system 103 may be a Fourier spectrometric optical system configured to obtain the interferogram.

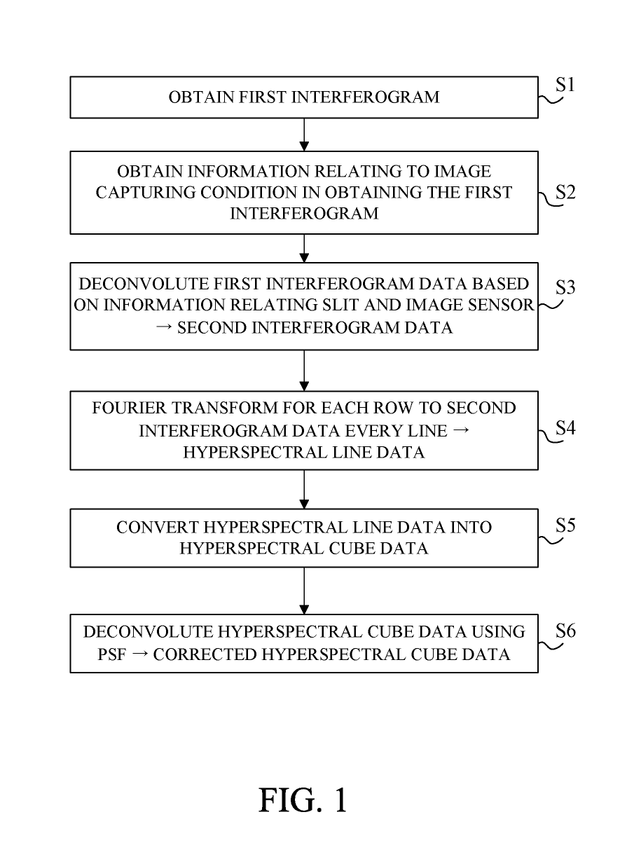

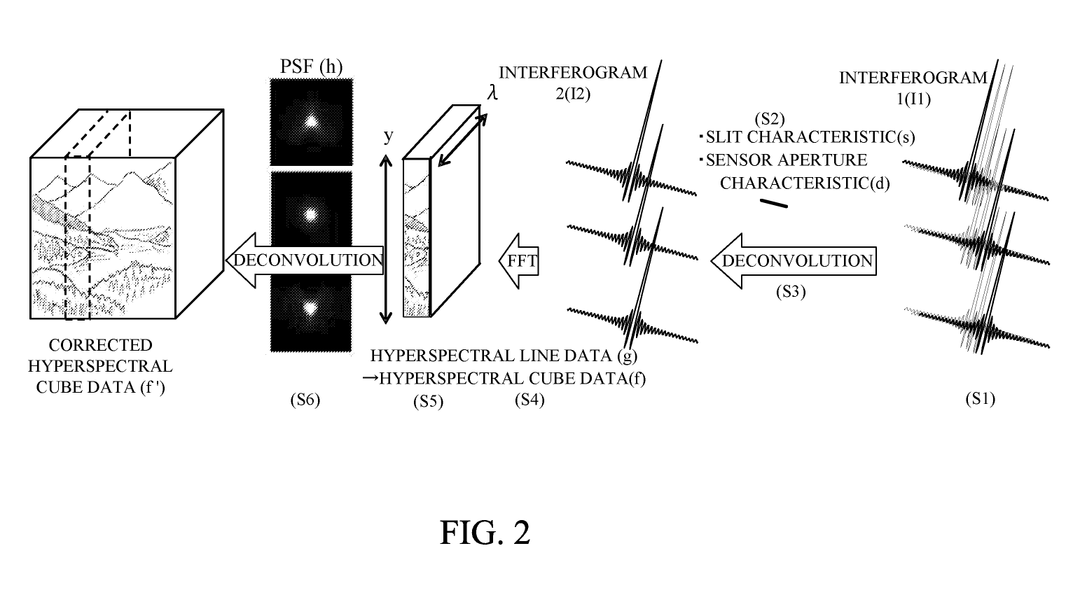

The data processor 106 that includes a computer, such as a CPU or a MPU, performs spectroscopic data processing illustrated in a flowchart in FIG. 1 and illustrated in a conceptual view of FIG. 2 in accordance with the spectroscopic data processing program as a computer program. In FIGS. 1 and 2, a symbol S represents the step. The data processor 106 corresponds to the first processor, a second processor, and a third processor.

In the step S1, the data processor 106 obtains first interferogram data (interferogram 1) from the image sensor 104.

The first interferogram data is acquired in this step S1 as modelled by the following expressions (1) to (3).

g=f [symbol] h (1)

I₂= [symbol] [g] (2)

I₁=I₂ [symbol] s [symbol] d (3)

Herein, g is hyperspectral cube data on the slit 102 of the light that has passed the image capturing optical system 101, f is ideal hyperspectral cube data, h is PSF (point spread function) of the image capturing optical system, 101, s is a slit characteristic, and d is a (image) sensor characteristic. In addition, I₁ is first interferogram data (row data), and I₂ is second interferogram data (row data). A crossed circle means a convolution.

Directly acquired data to be used for the spectroscopic data processing in this embodiment is the first interferogram data (I₁) obtained from light that has passed the image capturing optical system 101, the slit 102, and the stereoscopic optical system 103, and reached the image sensor 104.

Next, in the step S2, the data processor 106 obtains information relating to the image capturing condition from metadata, such as Exif information, added to the first interferogram data. The information relating to the image capturing condition contains an identification number (lens ID) to identify the image capturing optical system (interchangeable lens) 101 used for the image capture (or to obtain the first interferogram data), a focal length, an F-number, and an object distance of the image capturing optical system 101 in the image capture, etc. A combination of the lens ID, the focal length, the F-number, and the object distance can specify the PSF and optical transfer function (“OTF”) of the image capturing optical system 101. The OTF is a frequency response of the PSF that can be calculated by Fourier-transforming the PSF. Since information of the PSF is equivalent with that of the OTF, the PSF is used for the following description.

The information relating to the image capturing condition also contains information relating to the slit 102, the spectroscopic optical system 103, and the image sensor 104 in the image capture. The information relating to the slit 102 contains a parameter, such as a width of the slit 102. The information relating to the spectroscopic optical system 103 contains a parameter representing an optical configuration of the spectroscopic configuration of the spectroscopic optical system 103. The stereoscopic optical system 103 can contain an interferometer configured to acquire an interferogram, etc. The information relating to the image sensor 104 contains a parameter representing a shape, a pitch, an aperture width, and an aperture ratio of a pixel.

This embodiment obtains the PSF of the image capturing optical system 101 as discrete data with a sampling pitch that does not cause aliasing. This PSF data may be calculated by a computer simulation based on lens design data etc. The PSF may be measured with an image sensor having a small pixel pitch. The pixel pitch at this time may be a pixel pitch that does not cause aliasing, as described above.

The image sensor has a finite width (a length of a side), and has an optical characteristic such that the optical image obtained in the image sensor is integrated. This fact affects the spatial resolution and the wavelength resolution. The PSF may be calculated for each wavelength in accordance with a wavelength resolution of the used image sensor and a measurable wavelength area in generating the PSF data of the image capturing optical system 101 with the computer simulation. When the wavelength resolution of the image sensor is low, the OTF calculated for each wavelength in the predetermined range may be weighted, synthesized, and used as a representative value for the wavelength resolution based on the spectroscopic characteristic of the light source and the wavelength resolution of the image sensor.

Next, in the step S3, the data processor 106 deconvolutes (performs first deconvolution processing for) the first interferogram data based on the information (first information) relating to the slit 102 and the image sensor 104 in the information relating to the image capturing condition. More specifically, the data processor 106 calculates the slit characteristic representing the response characteristic, such as the OTF of the slit 102, based on the width of the slit 102, and calculates the sensor characteristic representing the pixel aperture characteristic based on the shape, pitch, aperture width, and the aperture ratio of the pixel in the image sensor 104. Then, the data processor 106 provides a deconvolution using the slit characteristic and the sensor characteristic. Thereby, the data processor 106 generates second interferogram data (interferogram 2) as row data that is the first interferogram data from which degraded components caused by the slit characteristic and the pixel aperture characteristic are eliminated or reduced.

The deconvolution as a correction process to the first interferogram data in the step S3 can modelled as in the following expression (4) as a model that solves the expressions (1) to (3) in the reverse order.

I₂= [symbol] −1[ [symbol] {I₁}/[ [symbol] {s}· [symbol] {d}]] (4)

Herein, [symbol] {•} represents a Fourier transform and [symbol] {•} represents an inverse Fourier transform.

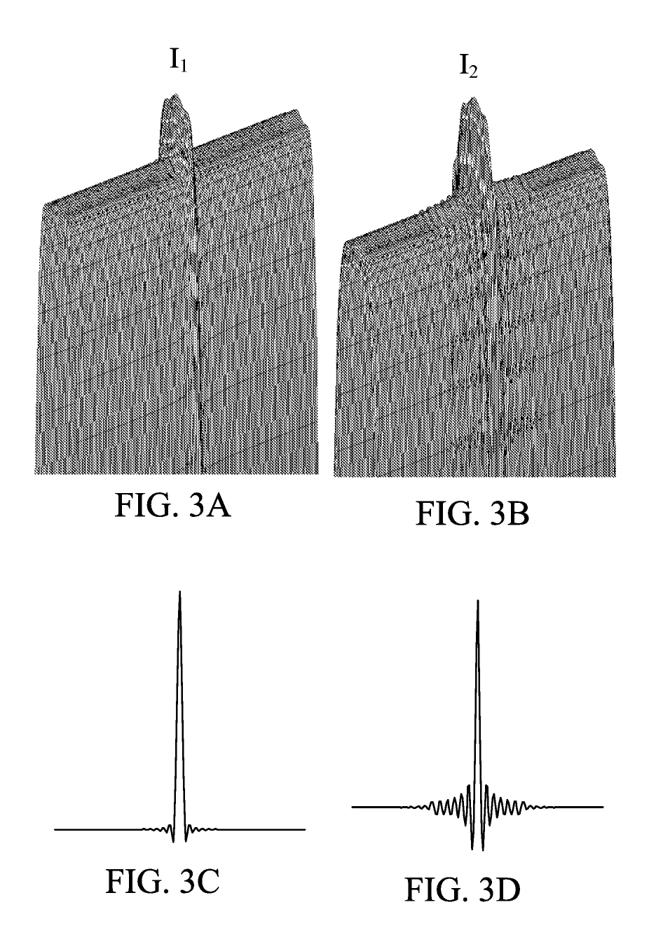

This correction process corresponds to a solution of a problem of calculating g as unknown information based on known information, such as h, s, d, and I₁. When the expressions (2) and (3) are modified into a frequency region, the expression in [ ] in the expression (4) can be obtained based on the convolution theorem. Next, the data processor 106 can correct the first interferogram data into the second interferogram data I₂ through the deconvolution, in which the degraded components caused by the slit 102 and the image sensor 104 are eliminated. FIGS. 3A to 3D illustrate the effects of this correction process.

FIGS. 3A and 3B illustrate I₁ and I₂, respectively, where the up direction represents a spectral intensity and the oblique depth direction represents a wavelength. FIGS. 3C and 3D illustrate sections in the wavelength directions of I₁ and I₂. In FIGS. 3A to 3D, I₁ illustrated in FIGS. 3A and 3C cannot be acquired as correct spectral data since the interferogram degrades due to the influence of the slit 102 and the image sensor 104. I₂ illustrated in FIGS. 3B and 3D is second interferogram in which the degradations under influence of the slit 102 and the image sensor 104 are eliminated from the first interferogram data by the deconvolution using the slit characteristic and the sensor characteristic for each inter-slit area. Spectral data (wavelength resolution) in I₂ is more precise than that in I₁.

Next, in the step S4, the data processor 106 performs a one-dimensional Fourier transform (fast Fourier transform) for the second interferogram data (row data). When this Fourier transform is performed for each of data areas corresponding to a plurality of inter-slit areas in the second interferogram data, hyperspectral line data (g) corresponding to the slit-shaped image capturing area can be obtained.

The processing in the step S5 is modelled by the following expression (5).

g= [symbol] {I₂} (5)

In the step S5, the data processor 106 combines the multi-spectral line data generated for each image capturing area or arranges it in a predetermined order, and generates hyperspectral cube data (f) as multi-wavelength image data. The hyperspectral line data and hyperspectral cube data correspond to the multi-spectral data.

Next, in the step S6, the data processor 106 deconvolutes (performs the correction process for) the hyperspectral cube data using the PSF (second information) of the image capturing optical system 101. Thereby, the data processor 106 generates corrected hyperspectral cube data (f′) as corrected multi-spectral data. The corrected hyperspectral cube data is data in which a degraded component caused by the PSF of the image capturing optical system 101 is removed or reduced from the hyperspectral cube data. The data processor 106 stores the generated, corrected hyperspectral cube data in the memory 107 illustrated in FIG. 6 or outputs it to the outside.

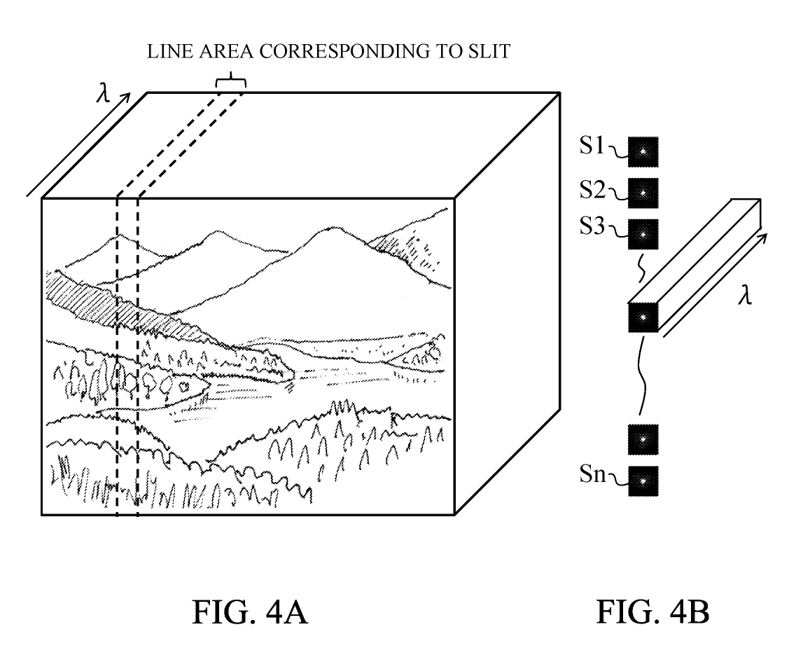

FIGS. 4A and 4B illustrate a relationship in the deconvolution in the step S6 between the hyperspectral cube data and the PSF of the image capturing optical system 101. The step S6 performs a deconvolution for each wavelength λ to each data area corresponding to each hyperspectral line data in the hyperspectral cube data as illustrated in FIG. 4A and to each of the plurality of inter-slit areas. The PSF of the image capturing optical system 101 used at that time is corresponding PSF for each inter-slit area (s1, s2, s3, . . . , sn) and for each wavelength λ, as illustrated in FIG. 4B. The data processor 106 can perform a deconvolution illustrated in the following expression (6) for each hyperspectral cube data in a shift invariant range in which the PSF of the image capturing optical system 101 can be considered equal.

f= [symbol] ⁻¹[ [symbol] {g}/ [symbol] {h}] (6)

The hyperspectral cube data may be deconvoluted for each wave number.

The data processor 106 may generate the corrected hyperspectral cube data by performing the second deconvolution processing for the multi-spectral line data and by combining (arranging in the predetermined order) the obtained, corrected multi-spectral line data.

The correction processing described in this embodiment is the deconvolution processing using a so-called inverse filter. However, a division by zero in the division and amplified noises may actually occur. Accordingly, the deconvolution processing may use a Wiener filter, a Richardson-Lucy algorithm, a method using a variety of regularizations, etc. In a (nonvariant) range in which the PSF of the image capturing optical system 101 cannot be considered equal, a good correcting effect can be obtained by the deconvolution processing by switching a deconvolution filter in the real space.

This embodiment can restrain the degradation of the data precision (wavelength resolution) caused by the image degradation in the image capturing optical system 101 and the spectrum deterioration in the slit 102 in the multi-channel Fourier spectroscopic imaging, and can provide well corrected hyper spectral cube data.

This embodiment performs a deconvolution as the correction process in the step S6, but may perform another process.

### Second Embodiment

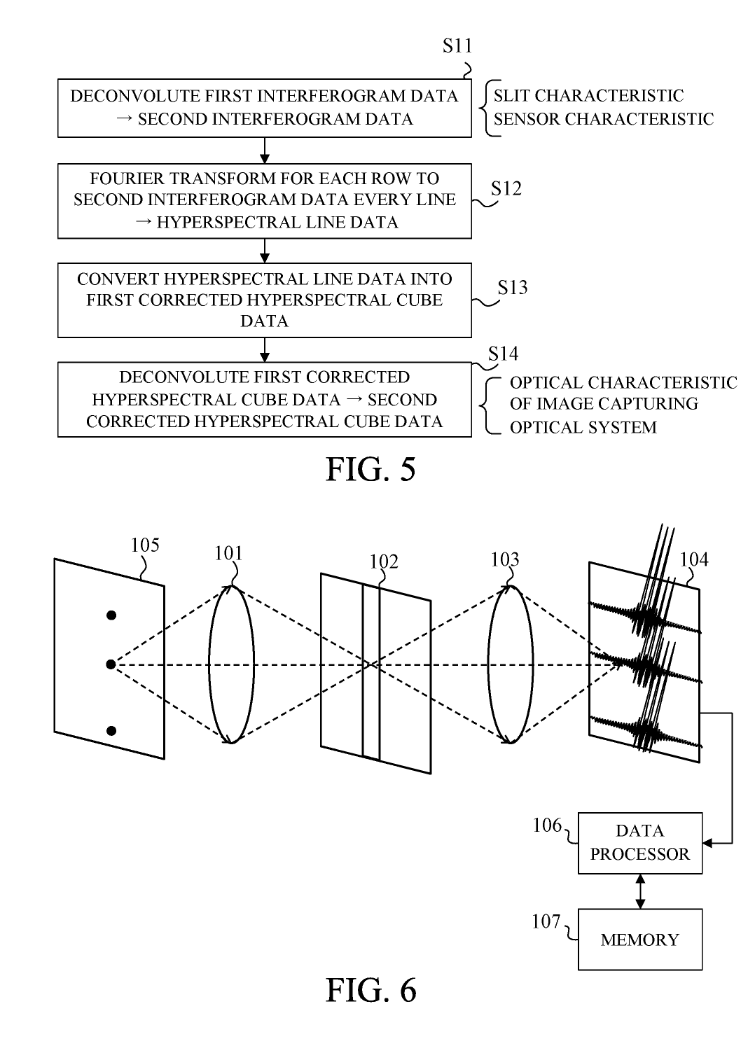

Next, a description will be given of a second embodiment of the present invention. A flowchart in FIG. 5 illustrates a stereoscopic data processing flow according to this embodiment. A configuration of the image capturing apparatus according to this embodiment is the same as that according to the first embodiment, and those components, which are corresponding elements in the first embodiment, will be designated by the same reference numerals.

In the hyperspectral imaging, an object space in which hyperspectral cube data is acquired is different according to a variety of applications and the image capturing optical system 101 is accordingly different. For example, a wide-angle lens is used for the image capturing optical system 101 to obtain wide-angle information, and a telephoto lens is used to telegraphically obtain detailed information of the ground from the sky. When the image capturing optical system 101 is interchangeable to the stereoscopic optical system 103 and the image sensor 104, the image capturing apparatus becomes more convenient. The hyperspectral cube data may be independently corrected for each of the spectral area and the space area according to the optical system interchangeable type image capturing apparatus.

As illustrated in the step S11 in FIG. 5, the data processor 106 generates the second interferogram data that is made by correcting the first interferogram data through the deconvolution using slit characteristic and the sensor characteristic described in the first embodiment.

In the step S12, the data processor 106 generates the hyperspectral line data through a Fourier transform to the second interferogram data. In the step S13, the data processor 106 generates the first corrected hyperspectral cube data by arranging the hyperspectral line data for each image capturing area in the predetermined order.

Next, in the step S14, the data processor 106 generates the second corrected hyperspectral cube data by correcting the first corrected hyperspectral cube data with the space area using the PSF as the optical characteristic of the image capturing optical system 101. The PSF of the image capturing optical system 101 used herein is that of the image capturing optical system 101 used to obtain the first interferogram data. The second corrected hyperspectral cube data corresponds to the corrected hyperspectral cube data in the first embodiment.

Instead of always generating the corrected hyperspectral cube data for the entire object space, the corrected hyperspectral cube data may be generated for the partial space area selected in the object space. For example, when the first corrected hyperspectral cube data is generated, the user may select the partial space area for generating the second corrected hyperspectral cube data in the object space through an operation unit in the image capturing apparatus, such as a touch panel and a switch. The data processor 106 generates the PSF of the image capturing optical system 101 corresponding to the partial space area designated by the user, performs a correction process (deconvolution), and generates the second corrected hyperspectral cube data.

The data processor 106 may store the first corrected hyperspectral cube data in the memory 107, and perform the correction process for the stored first corrected hyperspectral cube data rather than the second corrected hyperspectral cube data.

The same optical characteristic, such as the PSF or OTF, may be used by separating the correction process between the interferogram data and the hyperspectral cube data as in this embodiment. In other words, once the previous optical characteristic is stored in the memory 107, the optical characteristic may be simply read out of the memory 107 without arduously calculating it whenever the image is captured with the same image capturing condition as the previous one. Thus, the correction process for the hyperspectral cube data can become faster.

Each embodiment can obtain the corrected multi-spectral data with the maintained data precision, even when the image deteriorates in the image capturing optical system and the spectrum deteriorates in the slit in the multi-channel Fourier spectroscopic imaging.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-081970, filed Apr. 15, 2016, which is hereby incorporated by reference herein in its entirety.

What is claimed is:

1. A spectroscopic data processing apparatus configured to process first interferogram data obtained by separating through a spectroscopic optical system light on a slit imaged by an image capturing optical system and by capturing an image through an image sensor, the spectroscopic data processing apparatus comprising:
a first processor configured to deconvolute the first interferogram data using first information relating to the slit and the image sensor when the first interferogram data is obtained and to generate second interferogram data;
a second processor configured to generate multi-spectral data by Fourier-transforming the second interferogram data; and
a third processor configured to generate corrected multi-spectral data by performing a correction process for the multi-spectral data using second information relating to an optical transfer function or a point spread function of the image capturing optical system.

2. The spectroscopic data processing apparatus according to claim 1, wherein the first processor deconvolutes the first interferogram data using the first information corresponding to each of a plurality of areas in the slit.

3. The spectroscopic data processing apparatus according to claim 1, wherein the second processor generates the multi-spectral data by performing a one-dimensional Fourier transform for the second interferogram data for each data area corresponding to each of a plurality of areas in the slit.

4. The spectroscopic data processing apparatus according to claim 1, wherein the third processor performs the correction process for the multi-spectral data for each data area corresponding to each of a plurality of areas in the slit.

5. The spectroscopic data processing apparatus according to claim 1, wherein the correction process includes a deconvolution for each wavelength or wave number.

6. The spectroscopic data processing apparatus according to claim 1, wherein the first information and the second information is acquired from the first interferogram data to which metadata is added.

7. An image capturing apparatus comprising:
an image capturing system configured to separate through a spectroscopic optical system light on a slit imaged by an image capturing optical system and to photoelectrically convert separated light through an image sensor; and
a spectroscopic data processing apparatus configured to process first interferogram data obtained by the image sensor,
wherein the spectroscopic data processing apparatus includes:
a first processor configured to deconvolute the first interferogram data using first information relating to the slit and the image sensor when the first interferogram data is obtained and to generate second interferogram data;
a second processor configured to generate multi-spectral data by Fourier-transforming the second interferogram data; and
a third processor configured to generate corrected multi-spectral data by performing a correction process for the multi-spectral data using second information relating to an optical transfer function or a point spread function of the image capturing optical system;
a first processor configured to deconvolute the first interferogram data using first information relating to the slit and the image sensor when the first interferogram data is obtained and to generate second interferogram data;
a second processor configured to generate multi-spectral data by Fourier-transforming the second interferogram data; and
a third processor configured to generate corrected multi-spectral data by performing a correction process for the multi-spectral data using second information relating to an optical transfer function or a point spread function of the image capturing optical system.

8. A spectroscopic data processing method for processing first interferogram data obtained by separating through a spectroscopic optical system light on a slit imaged by an image capturing optical system and by capturing an image through an image sensor, the spectroscopic data processing method comprising:
a first process configured to deconvolute the first interferogram data using first information relating to the slit and the image sensor when the first interferogram data is obtained and to generate second interferogram data;
a second process configured to generate multi-spectral data by Fourier-transforming the second interferogram data; and
a third process configured to generate corrected multi-spectral data by performing a correction process for the multi-spectral data using second information relating to an optical transfer function or a point spread function of the image capturing optical system.

9. A non-transitory computer-readable storage medium storing a computer program that enables a computer to execute a spectroscopic data processing method for processing first interferogram data obtained by separating through a spectroscopic optical system light on a slit imaged by an image capturing optical system and by capturing an image through an image sensor, the spectroscopic data processing method comprising:
a first process configured to deconvolute the first interferogram data using first information relating to the slit and the image sensor when the first interferogram data is obtained and to generate second interferogram data;
a second process configured to generate multi-spectral data by Fourier-transforming the second interferogram data; and
a third process configured to generate corrected multi-spectral data by performing a correction process for the multi-spectral data using second information relating to an optical transfer function or a point spread function of the image capturing optical system.
